(19) United States
(12) Patent Application Publication
(10) Pub. No.: US 2002/0088336 A1
(43) Pub. Date: Jul. 11, 2002

(54) Method of identifying pieces of music

(76) Inventor: Volker Stahl, Aachen (DE)

Correspondence Address: U.S. Philips Corporation, 580 White Plains Road, Tarrytown, NY, 10591, US

(21) Appl. No.: 09/995,460

(22) Filed: Nov. 27, 2001

(30) Foreign Application Priority Data
Nov. 27, 2000 (DE) 10058811.5

(51) Int. Cl. G10H 1/26

(52) U.S. Cl. 84/609

(57) ABSTRACT

The invention relates to a method of identifying pieces of music. According to the invention, at least a fragment (MA) of a melody and/or a text of the piece of music to be identified is supplied to an analysis device (1) which determines conformities between the melody and/or text fragment (MA) and pieces of music (MT) which are known to the analysis device (1). The analysis device (1) then selects at least one of the known pieces of music (MT) with reference to the determined conformities and supplies the identification data (ID), for example, the title or the performer of the selected piece of music (MT) and/or at least a part of the selected piece of music (MT) itself.

The invention relates to a method of identifying pieces of music and to an analysis device for performing such a method.

A large number of people frequently experience that they hear music, for example, in public spaces such as discotheques, gastronomy establishments, department stores etc. or on the radio and would like to know the performer and/or composer as well as the title so as to acquire the piece of music, for example, as a CD or as music file via the Internet. The relevant person often remembers only given fragments of the desired piece of music at a later stage, for example, he remembers given fragments of the text and/or the melody. When the person is lucky enough to get into touch with extremely well-informed staff in a specialized shop, he may, inter alia, sing or hum these music fragments or speak parts of the text to the staff members in the shop, whereupon the relevant staff member can identify the piece of music and state the title and performers. However, in many cases this is not possible, either because the shop assistants themselves do not know or remember the title or because there is no directly addressable staff available such as, for example, when ordering through the Internet.

It is an object of the present invention to provide a method of automatically identifying pieces of music and an appropriate device for performing this method. This object is solved by the invention as defined in claims 1 and 13, respectively.

According to the invention, at least a fragment of a melody and/or a text of the piece of music to be identified, for example, the first bars or a refrain is fed into an analysis device. In this analysis device, different conformities between the melody and/or text fragment and other pieces of music or parts thereof, which are known to the analysis device, are determined. In this sense, the analysis device knows all the pieces of music to which it has access and whose associated data such as title, performer, composer, etc., can be queried. These pieces of music may be stored in one or several data banks. For example, different data banks of individual production companies may be concerned, which can be queried by the analysis device via a network, for example, the Internet.

Conformities are determined by comparing the melody and/or text fragment with the known pieces of music (or parts thereof), for example, while using one or more different sample classification algorithms. In the simplest case, this is a simple correlation between the melody and/or text fragment and the available known pieces of music. This is at least possible when an original fragment of the piece of music to be identified is supplied so that it is possible to start from a fixed speed which conforms to the speed of the “correct” piece of music which is known to the analysis device.

Based on the determined conformities, at least one of the known pieces of music is then selected in so far as a piece of music is found anyway, which has a defined minimal extent of conformity with the melody and/or text fragment input.

Subsequently, identification data such as, for example, the title, the performer, the composer or other information are supplied. Alternatively or additionally, the selected piece of music itself is supplied. For example, such an acoustic output may be effected to verify the piece of music. When a user hears the supplied piece of music, he can even check once more whether it is the piece searched for and only then supply the identification data. When none of the pieces of music is selected, because, for example, there is no defined minimal extent of conformity between any one of the pieces of music, then, for example, the text “no identification possible” is supplied in accordance with this information.

Preferably, not only one piece of music is supplied but it is also possible to supply a plurality of pieces of music and/or their identification data for which most conformities were determined, or for offering these pieces of music and/or their identification data for supply. This means that not only the title with most conformities but also the n (n =1, 2, 3, . . . ) most similar titles are supplied, and the user can listen to the consecutive titles for the purpose of verification or be supplied with the identification data of all n titles.

In a particularly preferred embodiment, given characteristic features of the melody and/or text fragment are extracted for the purpose of determining conformity. A set of characteristic features characterizing the melody and/or text fragment is then determined from these determined characteristic features. Such a set of characteristic features quasi corresponds to a “fingerprint” of each piece of music. The set of characteristic features is then compared with sets of characteristic features each characterizing the pieces of music which are known to the analysis device. This has the advantage that the quantities of data to be processed are considerably smaller, which speeds up the overall method. Moreover, the data bank no longer needs to store the complete pieces of music or parts of the pieces of music with all information in this case, but only the specific sets of characteristic features are stored so that the required memory location will be considerably smaller.

Advantageously, a melody and text fragment input is applied to a speech recognition system. The relevant text may also be extracted and separately applied to the speech recognition system. In this speech recognition system, the recognized words and/or sentences are compared with texts of the different pieces of music. To this end, the texts should of course also be stored as characteristic features in the data banks. To speed up the speech recognition, it is sensible when the language of the text fragment input is indicated in advance so that the speech recognition system only needs to access the required libraries for the relevant language and does not needlessly search other language libraries.

The melody and text fragment may also be applied to a music recognition system which compares, for example, the recognized rhythms and/or intervals with the characteristic rhythms and/or intervals of the stored pieces of music and in this way finds a corresponding piece as regards the melody.

It is, for example, also possible to analyze melody and text separately and separately search for a given piece of music via both ways. Subsequently, it is compared whether the pieces of music found via the melody correspond to the pieces of music found via the text. Otherwise, one or more pieces of music are selected as pieces of music with most conformities from the pieces of music found via the different ways. In this case, a weighting may be performed in which it is checked with which probability a piece of music found via a given way is the correctly selected piece of music.

It is also possible to supply only one melody or a melody fragment without a text or a text of a piece of music or a text fragment without the associated melody.

According to the invention, an analysis device for performing such a method should comprise means for supplying a fragment of a melody and/or a text of the piece of music to be identified. Moreover, it should comprise a memory with a data bank comprising several pieces of music or parts thereof, or means for accessing at least such a memory, for example, an Internet connection for access to other Internet memories. Moreover, this analysis device requires a comparison device for determining conformities between the melody and/or text fragment and the different pieces of music or its parts, as well as a selection device for selecting at least one of the pieces of music with reference to the determined conformities. Finally, the analysis device comprises means for supplying identification data of the selected piece of music and/or the selected piece of music itself.

Such an analysis device for performing the method may be formed as a self-supporting apparatus which comprises, for example, a microphone as a means for supplying the melody and/or text fragment, in which microphone the user can speak or sing the text fragment known to him or can whistle or hum a corresponding melody. A piece of music can of course also be played back in front of the microphone. In this case, the output means preferably comprise an acoustic output device, for example, a loudspeaker with which the selected piece of music or a plurality of selected pieces of music may be entirely or partly reproduced for the purpose of verification. The identification data may also be supplied acoustically via this acoustic output device. Alternatively or additionally, the analysis device may, however, also comprise an optical output device, for example, a display on which the identification data are shown. The analysis device preferably also comprises a corresponding operating device for verifying the output of pieces of music for the purpose of selecting offered pieces of music to be supplied or for supplying helpful additional information for the identification, for example, the language of the text, etc. Such a self-sufficient apparatus may be present, for example, in media shops where it can be used to advise customers.

In a particularly preferred embodiment, the analysis device for supplying the melody and/or text fragment comprises an interface for receiving corresponding data from a terminal apparatus. Likewise, the means for supplying the identification data and/or the selected piece of music are realized by means of an interface for transmitting corresponding data to a terminal apparatus. In this case, the analysis device may be at any arbitrary location. The user can then supply the melody or text fragment to a communication terminal apparatus and thus transmit it to the analysis device via a communication network.

Advantageously, the communication terminal apparatus to which the melody and/or text fragment is supplied is a mobile communication terminal apparatus, for example, a mobile phone. Such a mobile phone has a microphone as well as the required means for transmitting the recorded acoustic signals via a communication network, here a mobile radio network, to an arbitrary number of other apparatuses. This method has the advantage that the user can immediately establish a connection with the analysis device via his mobile phone when he hears the piece of music, for example, in the discotheque or as background music in a department store and can “play back” the current piece of music via the mobile phone to the analysis device. With such a fragment of the original music, an identification is considerably easier than with a music and/or text fragment sung or spoken by the user himself, which fragments may be considerably deformed.

The supply of identification data and the acoustic output of the selected piece of music or a part thereof are also effected through a corresponding interface via which the relevant data are transmitted to a user terminal. This terminal may be the same terminal apparatus, for example, the user's mobile phone to which the melody and/or text fragment was supplied. This may be done on-line or off-line. The selected piece of music or the selected pieces of music or parts thereof, for example, for verification is then supplied via the loudspeaker of the terminal apparatus. The identification data such as title and performer as well as possibly also selectable output offers may be transmitted, for example, by means of SMS on the display of the terminal apparatus.

The selection of an offered piece of music, but also other control commands or additional information for the analysis device can be effected by means of the conventional operating controls, for example, the keyboard of the terminal apparatus.

The data may, however, also be supplied via a natural speech dialogue, which requires a corresponding speech interface, i.e. a speech recognition and speech output system in the analysis device.

Alternatively, the search may also be effected off-line, i.e. after inputting the melody and/or text fragment and after inputting other commands and information, the user or the analysis device interrupts the connection with the analysis device. After the analysis device has found a result, it transmits this result, for example, via SMS or via a call through a speech channel back to the user's communication terminal apparatus.

In such an off-line method, it is also possible for the user to indicate another communication terminal apparatus, for example, his home computer or an e-mail address to which the result is transmitted. The result can then also be transmitted in the form of a HTML document or in a similar form. The indication of the transmission address, i.e. of the communication terminal apparatus to which the results are to be transmitted may either be effected by corresponding commands and indications before or after inputting the music and/or text fragment. However, it is also possible for the relevant user to explicitly register in advance with a service provider who operates the analysis device in which the required data are stored.

In a particularly preferred embodiment, it is optionally possible that, in addition to the selected piece of music or the associated identification data, further pieces of music or their identification data are supplied or offered for supply, which are similar to the relevant selected piece of music. This means that, for example, music titles are indicated as additional information having a style which is similar to that of the recognized music titles so as to enable the user to get to know further titles in accordance with his own taste, which titles he might then like to buy.

The similarity between two different pieces of music may be determined on the basis of psychoacoustical ranges such as, for example, very strong or weak bass, given frequency variations within the melody, etc. An alternative possibility of determining the similarity between two pieces of music is to use a range matrix which is set up by way of listening experiments and/or market analyses, for example consumer behavior analyses.

These and other aspects of the invention are apparent from and will be elucidated with reference to the embodiments described hereinafter.

### IN THE DRAWINGS

FIG. 1 shows diagrammatically the method according to the invention for an on-line search, using a mobile phone for inputting and outputting the required data,

FIG. 2 shows diagrammatically the method according to the invention for an off-line search, using a mobile phone for inputting the required data and a PC for outputting the resultant data,

FIG. 3 shows a range matrix for determining the similarity between different pieces of music.

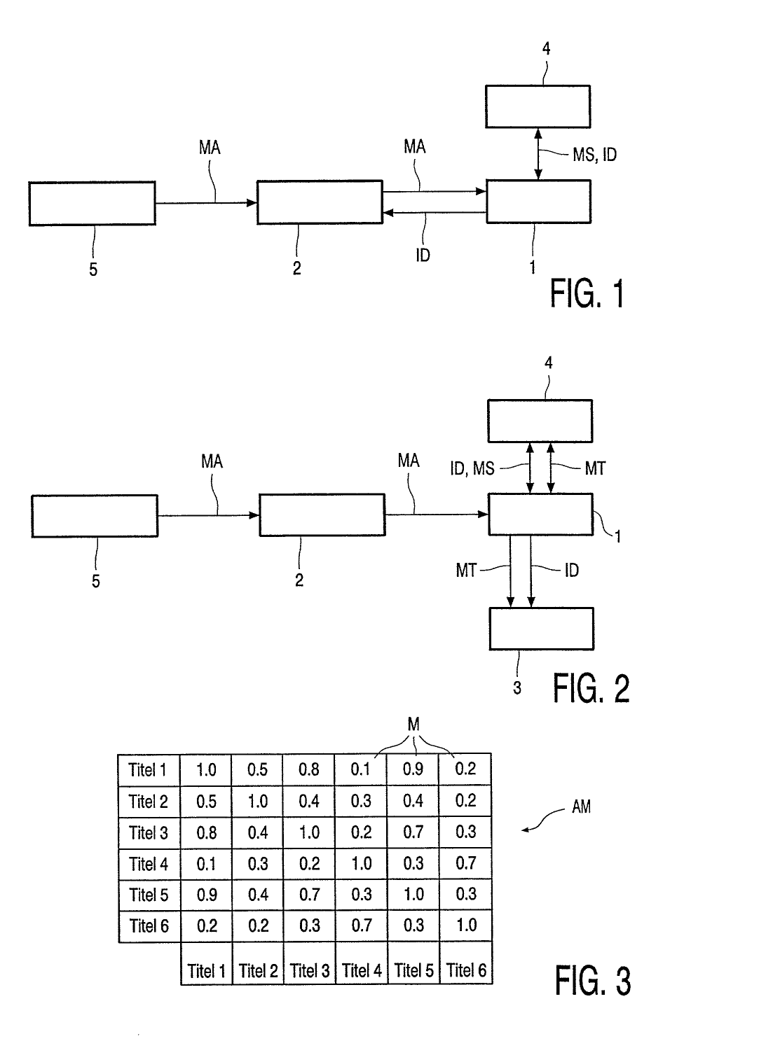

In the method shown in FIG. 1, a user uses a mobile phone 2 so as to communicate with the analysis device 1. To this end, a melody and/or text fragment MA of a piece of music currently being played by an arbitrary music source 5 in the neighborhood of the user is detected by a microphone of the mobile phone 2. The melody and/or text fragment MA is transmitted via a mobile phone network to the analysis device 1 which must have a corresponding connection with the mobile phone network or with a fixed telephone network and can accordingly be dialled by the user via this telephone network.

In principle, a commercially available mobile phone 2 may be used which may be modified to achieve a better transmission quality. The control of the analysis device 1 via the mobile phone 2 may either be realized via corresponding menu controls by means of keys (not shown) on the mobile phone 2. However, a speech-controlled menu may also be used.

Given characteristic features are extracted by the analysis device 1 from the obtained melody and/or text fragment MA. A set of characteristic features characterizing the melody and/or text fragment MA is then determined from these determined characteristic features. The analysis device 1 communicates with a memory 4 comprising a data bank which comprises corresponding sets of characteristic features MS each characterizing different pieces of music. This data bank also comprises the required identification data, for example, the titles and performers of the relevant associated pieces of music. For comparing the characterizing set of characteristic features of the melody and/or text fragment MA with the sets of characteristic features MS stored in the data bank of the memory 4, correlation coefficients between the sets of characteristic features to be compared are determined by the analysis device 1. The value of these correlation coefficients represents the conformities between the relevant sets of characteristic features. This means that the largest correlation coefficients of the set of characteristic features MS stored in the memory 4 is associated with a piece of music having the greatest conformity with the melody and/or text fragment MA supplied to the mobile phone 2. This piece of music is then selected as the associated identified piece of music and the associated identification data ID are transmitted on-line by the analysis device 1 to the mobile phone 2 on which they are shown, for example, on its display.

In the method described, in which the melody and/or text fragment MA is directly supplied by a music source 5, the identification is simplified in so far that, in contrast to normal speech or sample recognition, it may be assumed that pieces of music are always played at almost the same speed so that at least a fixed common time frame between the music and/or text fragment supplied for identification and the relevant correct piece of music to be selected can be assumed.

FIG. 2 shows a slightly different method in which the identification takes place off-line.

The piece of music to be identified or a melody and/or text fragment MA of this piece of music is also supplied through an external music source 5 to a mobile phone 2 of the user and the information is subsequently transmitted to the analysis device 1. Also the kind of analysis by way of a predetermination of a set of characteristic features MS characterizing the melody and/or text fragment is effected similarly as in the first embodiment.

In contrast to the embodiment of FIG. 1, however, the result of the identification is not transmitted back to the user's mobile phone 2. Instead, this result is sent by e-mail via the Internet or as a HTML page to a PC 3 of the user or to a PC or e-mail address indicated by the user.

In addition to the identification data, the relevant piece of music MT itself or at least a fragment thereof is also transmitted to the PC so that the user can listen to this piece of music for the purpose of verification. Together with the sets of characteristic features characterizing the pieces of music, these pieces of music MT (or their fragments) are stored in the memory 4.

Order forms for a CD with the searched piece of music, commercial material or additional information may be sent additionally. Additional information may be sent to the user, for example, further music titles which are similar to the identified music titles.

The similarity is determined via a range matrix AM as is shown in FIG. 3. The elements M of this range matrix AM are similarity coefficients, i.e. values which indicate a measure of the similarity between two pieces of music. The pieces of music are of course always a hundred percent similar to themselves so that a value of 1.0 is plotted in the corresponding fields. In the relevant example, the pieces of music with the title 1 and the title 3 as well as the title 5 are particularly similar. In contrast, a piece of music with the title 4 or 6 is completely dissimilar to the piece of music with the title 1. A user, whose piece of music was identified as title 1, will therefore be additionally offered the music pieces with titles 3 and 5.

Such a range matrix AM may also be stored in the memory 4. It may be determined, for example, on the basis of subjective listening experiments with a comparatively large test audience or on the basis of consumer behavior analysis.

The analysis device 1 may be arranged at an arbitrary location. It should only have the required interfaces for connection with the conventional mobile phones or have an Internet connection. The analysis device 1 is shown as a coherent apparatus in the Figures. Different functions of the analysis device 1 may of course also be distributed among different apparatuses connected together in a network. The functions of the analysis device may largely or even completely be realized in the form of software on appropriate computers or servers with a sufficient computing or storage capacity. It is neither necessary to use a single central memory 4 comprising a coherent data bank, but a multitude of memories may also be used which are present at different locations and can be accessed by the analysis device 1, for example, via the Internet or another network. In this case, it is particularly possible for different music production and/or sales companies to store their pieces of music in their own data banks and to allow the analysis device access to these different databanks. When reducing the characterizing information of the different pieces of music to sets of characteristic features, it should be usefully ensured that the characteristic features are extracted from the pieces of music by means of the same methods and that sets of characteristic features are composed in the same manner so as to achieve compatibility in this way.

The method according to the invention enables a user to easily acquire the data required for purchasing the desired music and to rapidly identify currently played music. Moreover, the method enables him to be informed about additional pieces of music which also correspond to his personal taste. This method is advantageous to music sales companies in so far as the potential customers can be offered exactly the music in which they are interested so that the desired target group is attracted.

1. A method of identifying pieces of music, the method comprising the steps of
supplying at least a fragment (MA) of a melody and/or a text of the piece of music to be identified to an analysis device (1),
determining conformities between the melody and/or text fragment (MA) and pieces of music (MT) or parts thereof known to the analysis device (1),
selecting at least one of the known pieces of music (MT) with reference to the determined conformities in so far as there is a defmed minimal extent of conformity,
supplying identification data (ID) of the selected piece of music (MT) and/or - supplying at least a part of the selected piece of music (MT) itself or, in so far as no piece of music (MT) is selected, supplying corresponding information.

2. A method as claimed in claim 1, characterized in that a plurality of pieces of music and/or their identification data, for which the greatest conformities were determined, is supplied and/or offered for supply.

3. A method as claimed in claim 1 or 2, characterized in that, for determining the conformities, given characteristic features of the melody and/or text fragment (MA) are extracted, a set of characteristic features characterizing a melody and/or text fragment (MA) is then determined from the determined characteristic features, and this characterizing set of characteristic features is compared with sets of characteristic features (MS) characterizing the known pieces of music (MT).

4. A method as claimed in claim 3, characterized in that, for comparing the characterizing set of characteristic features of the melody and/or text fragment (MA) with the sets of characteristic features (MS) stored in the data bank, correlation coefficients are determined between the sets of characteristic features to be compared, the values of said correlation coefficients representing the conformities between the relevant sets of characteristic features.

5. A method as claimed in any one of claims 1 to 4, characterized in that the supplied melody and/or text fragment, or a text extracted thereby is supplied to a speech recognition system, and words and/or sentences recognized in the speech recognition system are compared with texts of the different pieces of music.

6. A method as claimed in claim 5, characterized in that the language for the supplied text fragment is indicated for the purpose of speech recognition.

7. A method as claimed in any one of claims 1 to 6, characterized in that the melody and/or text fragment (MA) is supplied by a user to a communication terminal apparatus (2) and is transmitted via a communication network to the analysis device (1), and a selected piece of music (MT) and/or its identification data (ID) are transmitted for supply to a user-designated communication terminal apparatus (2, 3).

8. A method as claimed in claim 7, characterized in that the communication terminal apparatus (2) to which the melody and/or text fragment (MA) is supplied is a mobile communication terminal apparatus (2).

9. A method as claimed in claim 7 or 8, characterized in that the selected piece of music (MT) and/or its identification data (ID) are transmitted back for supply to the communication terminal apparatus (2) to which the melody and/or text fragment (MA) is applied.

10. A method as claimed in any one of claims 1 to 9, characterized in that in addition to the selected piece(s) of music and/or the associated identification data at least a further piece of music and/or its identification data which is similar to the selected piece(s) of music is supplied and/or offered for supply.

11. A method as claimed in claim 10, characterized in that the similarity between two pieces of music is determined on the basis of psychoacoustical ranges.

12. A method as claimed in claim 10 or 11, characterized in that the similarity between two pieces of music is determined on the basis of a range matrix (AM) which is set up with the aid of listening experiments and/or market analyses (consumer behavior analyses).

13. An analysis device (1) for performing a method as claimed in any one of claims 1 to 12, the device comprising
means for supplying at least a fragment (MA) of a melody and/or a text of the piece of music to be identified,
a memory (4) comprising a data bank with different pieces of music or parts thereof, or means for accessing at least such a memory,
a comparison device for determining conformities between the melody and/or text fragment (MA) and the different pieces of music (MT) or the parts thereof,
a selection device for selecting at least one of the pieces of music (MT) with reference to the determined conformities, in so far as there is a defined minimal extent of conformities, and
means for supplying identification data (ID) of the selected piece of music (MT) and/or the selected piece of music (MT) itself.

14. An analysis device as claimed in claim 13, characterized in that the analysis device comprises means for extracting given characteristic features of the melody and/or text fragment (MA) and for determining a set of characteristic features characterizing the melody and/or text fragment (MA) from the determined characteristic features, and in that a data bank of the memory (4) comprises corresponding sets of characteristic features (MS) each characterizing the pieces of music (MT).

15. An analysis device as claimed in claim 13 or 14, characterized in that the means for supplying the melody and/or text fragment comprise a microphone and the means for supplying the identification data and/or the selected piece of music comprise an acoustical output unit and/or an optical output unit.

16. An analysis device as claimed in any one of claims 13 to 15, characterized in that the means for supplying the melody and/or text fragment (MA) comprise an interface for receiving corresponding data from a terminal apparatus (2), and the means for supplying the identification data (ID) and/or the selected piece of music (MT) comprise an interface for transmitting corresponding data to a terminal apparatus (2, 3).

17. An analysis as claimed in any one of claims 13 to 16, characterized by means for selecting further pieces of music which are similar to the selected piece of music.
